(19) United States
(12) Patent Application Publication
(10) Pub. No.: US 2009/0224558 A1
(43) Pub. Date: Sep. 10, 2009

(54) LOCKING AND UNLOCKING MECHANISM FOR THE COVER OF A GLOVE COMPARTMENT

(76) Inventor: Ton Ickenroth, Heythuysen (NL)

Correspondence Address: Johnson Controls, Inc.;c/o Fletcher Yoder PC, P.O. Box 692289, Houston, TX, 77269, US

(21) Appl. No.: 12/350,808

(22) Filed: Jan. 8, 2009

(30) Foreign Application Priority Data
Jul. 14, 2006 (DE) 102006033043.9
Jun. 27, 2007 (EP) PCT/EP2007/005684

(51) Int. Cl. E05B 65/12

(52) U.S. Cl. 292/28

(57) ABSTRACT

A vehicle interior compartment, such as a glove compartment, has a cover and closure mechanism for the cover. The compartment is located in the vehicle interior paneling. Movable closing means can be actuated via actuating means to lock the cover. The movable closing means and the actuating means are arranged on the paneling.

### CROSS REFERENCE TO RELATED APPLICATIONS

This application claims priority from and the benefit of DE 10 2006 033 043.9, filed on Jul. 14, 2006, and PCT/EP2007/005684, filed on Jun. 27, 2007, both entitled “Locking and Unlocking Mechanism for the Cover of a Glove Compartment”, which are hereby incorporated by reference.

### BACKGROUND

The present invention relates to the closure mechanism for the cover of a compartment which is located in the paneling of the vehicle interior and is locked to the paneling at two points via movable closing means which can be actuated via an actuating means.

The generic locking mechanism is known for example from WO 95/27115, German utility model G 89 03 395.7 U1, Offenlegungsschriften DE 33 36 952 A1, DE 103 56 532 A1, DE 103 50 683 A1, DE 44 07 522 C1, DE 44 00 628 A1 and also German patent specification DE 103 54 645 B3. However, these locking mechanisms have the drawback that either the closing means itself or the actuating means is arranged on the cover; this leads to a costly cover which may also have visual drawbacks and often restricts the space available in the respective compartment.

There is a need, therefore, to provide a closure mechanism for the cover of a compartment located in the paneling of the vehicle interior, which mechanism does not have the drawbacks of the prior art.

### SUMMARY

The invention provides a closure mechanism for the cover of a compartment which is located in the paneling of the vehicle interior and can be locked to the paneling at two sides via movable closing means which can be actuated via an actuating means, wherein the movable closing means and the actuating means are arranged on the paneling.

A further solution, which is in accordance with the invention or preferred, to the problem posed is a closure mechanism for the cover of a compartment which is located in the paneling of the vehicle interior and can be locked to the paneling at two points via movable closing means which can be actuated via an actuating means, wherein the closing means have levers which rotate in opposite directions and are joined together via a linkage.

For a person skilled in the art, it was extremely surprising and quite unexpected that both closure mechanisms according to the invention can be manufactured simply and inexpensively. The cover of the respective compartment has no mechanical components and is thus simple to manufacture and can be incorporated into the respective vehicle interior over the entire area without having visually disadvantageous indentations, switches or the like.

According to the invention, the cover of the respective vehicle is reversibly lockable via two closing means on the paneling of the interior of a motor vehicle. These closing means are preferably arranged to the right and left of the respective cover. The closing means can be actuated via an actuating means. According to the invention, both the closing means and the actuating means are arranged on the paneling.

According to the invention or preferably, the closing means have levers which rotate in opposite directions and are joined together via a linkage. This embodiment has in particular the advantage that merely one actuating means is required and that the entire closure mechanism has an extremely simple mechanism. Closing pieces, for example bolts, which interact in a locking manner with indentations which are arranged on the cover, are preferably arranged on the levers.

Preferably, the cover is mounted on the paneling by means of hinges. Particularly preferably, the cover opens, as soon as it is unlocked, automatically, for example as a result of its inherent weight, spring pretensioning and/or a drive.

Preferably, an actuating means is arranged merely on a closing means.

In another preferred embodiment, a respective actuating means is arranged on both closing means.

The actuating means are triggered preferably by a triggering device which is particularly preferably also arranged on the paneling.

Preferably, the actuating means is/are arranged on the paneling.

Furthermore, both closing means can preferably be actuated by a triggering device which is preferably also arranged on the paneling.

In a further preferred embodiment, the actuating means is an electrical and/or mechanical means. Examples of means of this type include an electromagnet, a motor, a Bowden cable or a spring-loaded element.

### DRAWINGS

The invention will be described hereinafter with reference to FIGS. 1 to 4. This description is merely exemplary and does not restrict the general inventive idea. The following discussion applies equally to both closure mechanisms according to the invention. In the drawings:

FIG. 1 shows an embodiment of the locking mechanism according to the invention in the locked state;

FIG. 2 shows the locking mechanism according to FIG. 1 in the unlocked state;

FIG. 3 shows a further embodiment of the locking mechanism according to the invention; and

FIG. 4 shows still a further embodiment of the locking mechanism according to the invention.

### DETAILED DESCRIPTION

FIG. 1 shows the locking mechanism 1 according to the invention of the cover 2, for example of a glove compartment. This cover 2 is locked to the inner paneling of a motor vehicle using closure pieces 3, 3′ which are each arranged to the right and left of the cover. The closure pieces 3, 3′ are each arranged on levers 4, 4′. Both levers 4, 4′ are each mounted so as to be able to rotate about the axes of rotation 5, 5′. The two levers 4, 4′ are joined together via a linkage 6. An actuating means 8, in the present case an electromagnet, which can be used to actuate the closure mechanism in a locking and/or unlocking manner, is arranged on the left lever 4. The electromagnet 8 is connected to a triggering device 7. All mechanical or electrical means and also movable means of the locking are arranged on the inner paneling and not on the cover 2. A person skilled in the art will understand that the actuating means can also be a mechanical means. In this case, the triggering device 7 is also a mechanical means, for example a Bowden cable.

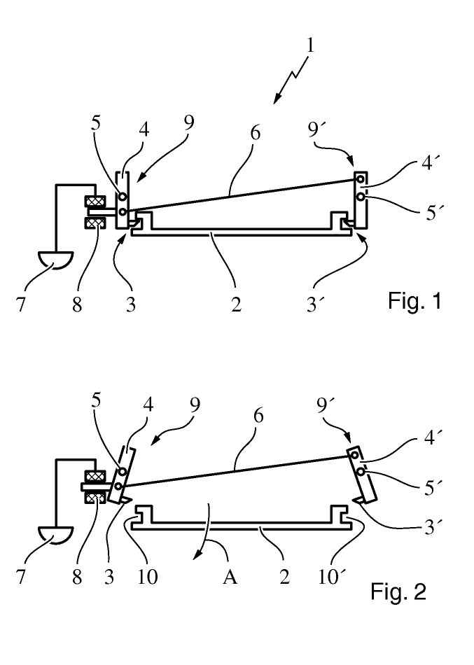

FIG. 2 shows the locking mechanism according to FIG. 1 in the unlocked state. The electromagnet 8 rotates the lever 4 in the clockwise direction, so that the closing piece 3 releases the cover 2 from the indentation 10. As the lever 4 is connected to the lever 4′ by means of the linkage 6, said lever 4′ is rotated in the anticlockwise direction and the closing piece 3′ slips out of the indentation 10′ in the cover. The cover 2 is thus unlocked and can swing up along a rotary joint (not shown), for example as a result of the inherent weight of said cover or resilient pretensioning. However, the cover can also be actuated by means of a motor. Once the cover has been opened or returned to its locked position, the closing pieces 3, 3′ are returned to the locking position and can be introduced into the indentation 10, 10′.

FIG. 3 shows the locking mechanism according to FIG. 1, wherein in the present case both actuating means 8, 8′ are electromagnets which bring closing pieces 3, 3′ to the right or to the left into an unlocking or locking position. Both electromagnets 8, 8′ are connected to the triggering device 7 by means of a cable 12. Both the triggering device 7 and the electromagnets 8, 8′ are located in the inner paneling 11 of the motor vehicle and not on the cover 2. The same applies to the closing pieces 3, 3′. Moreover, reference is made to the embodiments according to FIG. 1 and FIG. 2.

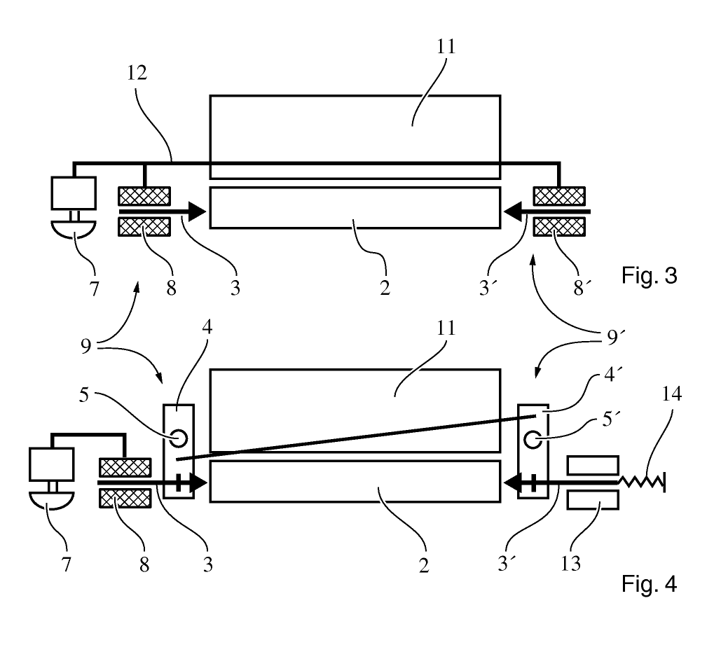

FIG. 4 shows substantially the locking mechanism according to FIGS. 1 and 2. In the present case, the closing piece 3 is spring-loaded so that it presses, once the electromagnet 8 has been switched off, the lever 4′, and thus also the lever 4, back into its original position. In this position, the cover 2 can again be locked in a very simple manner to the inner paneling, in that it is for example brought manually into the locking position. In this position, the closing pieces 3, 3′ then automatically engage with the indentation 10, 10′.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A closure mechanism for the cover of a compartment which is located in the paneling of the vehicle interior, comprising movable closing means which can be actuated via an actuating means to lock the cover to the paneling at two sides, wherein the movable closing means and the actuating means are arranged on the paneling.

2. The closure mechanism as recited in claim 1, wherein the closing means have levers which rotate in opposite directions and are joined together via a linkage.

3. The closure mechanism as recited in claim 1, wherein the levers have closing pieces which interact in a locking manner with indentations which are arranged on the cover.

4. The closure mechanism as recited in claim 1, wherein an actuating means is arranged on a closing means.

5. The closure mechanism as recited in claim 1, wherein a respective actuating means is arranged on the closing means.

6. The closure mechanism as recited in claim 5, wherein the actuating means is/are arranged on the paneling.

7. The closure mechanism as recited in claim 6, wherein the closing means can be actuated by a triggering device which is arranged on the paneling.

8. The closure mechanism as recited in claim 7, wherein the actuating means is an electrical and/or mechanical means.

9. The closure mechanism as recited in claim 8, wherein the actuating means is an electromagnet, a motor, a Bowden cable and/or a spring-loaded element.
